(19) United States
(12) Patent Application Publication
(10) Pub. No.: US 2022/0047121 A1
(43) Pub. Date: Feb. 17, 2022

(54) DISPOSABLE CONTAINER FOR USE IN A SINK

(71) Applicant: Maor Grinberg, Atlit (IL)

(72) Inventor: Maor Grinberg, Atlit (IL)

(21) Appl. No.: 17/512,955

(22) Filed: Oct. 28, 2021

Related U.S. Application Data
(63) Continuation of application No. 16/061,422, filed on Jun. 12, 2018.

(30) Foreign Application Priority Data
Dec. 23, 2015 (IL) 243154

(51) Int. Cl. A47K 1/06; E03C 1/186; E03C 1/264; B65F 1/00; E03C 1/26; B65F 1/14

(52) U.S. Cl. CPC A47K 1/06; E03C 1/186; E03C 1/264; B65F 2210/132; E03C 1/26; B65F 1/1415; B65F 2001/1489; B65F 1/002

(57) ABSTRACT

A disposable flexible container for installation into a sink. The sink comprises an upper opening and a bottom opening for draining, and the container respectively comprises an upper opening and a bottom opening. When installed in the sink, the walls of the container are adjacent or attached, fully or partially, to the sides of the sink, the container upper opening if fitted, fully or partially, to the sink upper opening, and the contain bottom opening is fitted, fully or partially, to the sink bottom opening.

### TECHNICAL FIELD

This disclosure relates generally to a method and a container for maintaining of a clean sink, and in particular to using a disposable container.

### BACKGROUND

A sink (also known as sinker, washbowl, hand basin, and wash-basin) is a bowl-shaped plumbing fixture used for washing hands, dishwashing, and other purposes. Sinks typically have taps (faucets) that supply hot and cold water and may include a spray feature to be used for faster rinsing. They also include a drain to remove used water; this drain may itself include a strainer and/or shut-off device and an overflow-prevention device. When a sink becomes stopped-up or clogged, a person will often resort to use a chemical drain cleaner or a plunger, though most professional plumbers will remove the clog with a drain auger (often called a “plumber's snake”). Sinks are made of many different materials. These include: Ceramic; Concrete; Copper; Enamel over steel or cast iron; Glass; Granite; Marble; Nickel; Plastic; Soapstone; Stainless steel; Stone; Terrazzo; Wood; and Polyester.

Self-rimming (top-mount) sinks sit in appropriately shaped holes roughly cut in the countertop (or substrate material) using a jigsaw or other cutter appropriate to the material at hand and are suspended by their rim. The rim then inherently forms a fairly close seal with the top surface of the countertop, especially when the sink is clamped into the hole from below. Bottom-mount or under-mount sinks are installed below the countertop surface. The edge of the countertop material is exposed at the hole created for the sink (and so must be a carefully finished edge rather than a rough cut). The sink is then clamped to the bottom of the material from below. Especially for bottom-mount sinks, silicone-based sealants are usually used to assure a waterproof joint between the sink and the countertop material.

Solid-surface plastic materials allow sinks to be made of the same plastic material as the countertop. These sinks can then easily be glued to the underside of the countertop material and the joint sanded flat, creating the usual invisible joint and completely eliminating any dirt-catching seam between the sink and the countertop. In a similar fashion, for stainless steel, a sink may be welded into the countertop; the joint is then ground to create a finished, concealed appearance.

A farmer's sink is a deep sink that has a finished front. Set onto a countertop, the finished front of the sink remains exposed. This style of sink requires very little “reach-over” to access the sink. A vessel sink is a free-standing sink, generally finished and decorated on all sides, that sits directly on the surface of the furniture on which it is mounted. These sinks have become increasingly popular with bathroom designers because of the large range of materials, styles and finishes which they can show to good advantage.

A bin bag or tin liner', ‘garbage bag’, or ‘trash bag’ is a disposable bag used to contain rubbish, trash, or garbage. Such bags are useful to line the insides of waste containers to prevent the insides of the receptacle from becoming coated in waste material. Most bags these days are made out of plastic, and are typically black in color. Plastic bags are a convenient and sanitary way of handling garbage, and are widely used. Plastic garbage bags are fairly lightweight and are particularly useful for messy or wet rubbish, as is commonly the case with food waste, and are also useful for wrapping up garbage to minimize odor. Plastic bags are often used for lining litter or waste containers or bins. This serves to keep the container sanitary by avoiding container contact with the garbage. After the bag in the container is filled with litter, the bag can be pulled out by its edges, closed, and tied with minimal contact with the waste matter.

Plastic bags for rubbish or litter are sold in a number of sizes at many stores in packets or rolls of a few tens of bags. Wire twist ties are sometimes supplied for closing the bag once full. Varying thicknesses are commonly manufactured—thicker bags are used for heavy duty applications such as construction waste, or in order to be able to withstand being compacted during recycling processes. Some bags have handles which may be tied, or holes through which the neck of the bag can be pulled. Most commonly, the plastic used to make bin bags is the rather soft and flexible LDPE (Low Density Polyethylene) or, for strength, LLDPE (Linear Low Density Polyethylene) or HDPE (High Density Polyethylene) are sometimes used.

Oxo-biodegradable plastic bags have the same strength as ordinary plastic and cost very little extra. They will degrade then biodegrade if they get into the open environment, but they can be recycled if collected during their useful life. They are designed so that they will not degrade deep in landfill and will not therefore generate methane. Oxo-biodegradable plastic does not degrade quickly in low temperature “windrow” composting, but it is suitable for “in-vessel” composting at the higher temperatures required by the animal by-products regulations. Oxo-biodegradable plastic is bio-assimilated by the same bacteria and fungi, which transform natural material such as twigs and leaves to cell biomass, like lignocellulosic materials. Oxo-biodegradable plastic is designed to degrade initially by a process which includes both photo-oxidation and thermo-oxidation, so it can degrade in the dark. Resin identification code 7 is applicable to biodegradable plastics.

A Sink net is disclosed in Patent Publication No. AU199950159A to Leigh Hincks, which is incorporated in its entirety for all purposes as if fully set forth herein. In this invention, a mesh with a flexible plastic rectangular surround is described, where each corner has a small metallic magnet to position and hold the device in the metal sink. The device is inserted into the sink to catch any refuse, such as food scraps, before they go down the drain, thereby preventing blockages in either the drains or the sewerage systems. The dimensions to be suitable to fit either a domestic or commercial sink. Three different designs, one with a mesh plug hole in which the plug is inserted. One plain device may be with diagonal cords with which to extract the device with the contents of the sink held within, and another plain device may be without any plughole or cords.

A disposable garbage storage bag with garbage storage bag cover for drainage opening of sink is described in Patent Publication No. JP 8310603A to Fukazawa Kiyoshi, which is incorporated in its entirety for all purposes as if fully set forth herein. The purpose of this invention is to improve a sanitary condition by fitting a garbage storage bag cover onto the top of a disposable garbage storage bag which is fitted onto the drainage opening of a sink for use in order that sticky substance whose adhesive ability is high due to propagation of various germs is prevented from adhering to the drainage opening of the sink. A garbage storage bag cover is integrally-disposed onto the top of a garbage storage bag fitted onto a drainage opening of a sink, and is fixed onto the garbage storage bag with a retaining ring. In the case of the drainage opening of the sink provided with the garbage storage bag, the garbage storage bag can be thrown away together with the garbage storage bag cover even if sticky substance whose adhesive ability is high due to propagation of various germs adheres or offensive odor occurs, so it is possible to ensure a good sanitary environment. As the garbage storage bag, a raw material whose draining ability is good, such as mesh-shaped vinyl unwoven cloth, polyethylene knitting, polyethylene film provided with punching is used.

Patent Publication No. JP 2013001562A to Akai Osamu entitled: “Bag holding frame and draining garbage bag mounting structure”, which is incorporated in its entirety for all purposes as if fully set forth herein, discloses a bag holding frame for holding a draining garbage bag with garbage accumulated inside such that the draining garbage bag can be thrown away without being touched, and a draining bag mounting structure using the bag holding frame. The draining garbage bag mounting structure includes a draining basket stored in a brain hole provided in the bottom face of the sink; the bag holding frame provided at the upper end of the drain hole; and the draining garbage bag with its opening held to the outer periphery of the bag holding frame. The outer periphery of the bag holding frame is formed with a groove part serving as a hook part. The draining garbage bag is hold to the outer periphery of the bag holding frame by locking an elastic string provided at the opening to the groove part, and the opening can be detect the groove part by the elastic deformation of the elastic string.

Patent Publication No. JP 2011098833A to Shinohara Misako entitled: “Variant shape sink corner strainer holding draining bag”, which is incorporated in its entirety for all purposes as if fully set forth herein, discloses a utensil which allows the usage of a commonly marketed general draining bag, prevents garbage from being seen from outside, and is easy in the installation of the draining bag and cleaning. In this utensil, a case with an upper portion having a shape of flange and without a bottom, covers a draining bag to prevent garbage from being seen from outside. A metal ring mounted on the sink with use of a sucking disk and the flange of the case firmly sandwiches the mouth of the bag from upside and downside, to prevent the bag from falling off. Since the case has no bottom, it is less likely to get dirty and easy in cleaning. Attaching a lid at night and the like for bug-proof and deodorant, obviates the need to dispose garbage, when the amount of garbage is small.

Patent Publication No. JP 2002322704A to Urano Kiichi entitled: “Plate for attachment of rubbish straining net of drain inlet and rubbish strainer”, which is incorporated in its entirety for all purposes as if fully set forth herein, discloses a plate for attachment of a rubbish straining net which can reliably strain rubbish contained in drainage about to flow out of a drain inlet, eliminate clogging easily even on the occurrence of the clogging, and prevent pollution of a river and the like. This plate is provided in a floor bottom in a sunken manner, and fitted into a fitting recess of a catch basin-shaped cover of the drain inlet, which is equipped with a drain hole in a central part, in such a manner as to be freely taken out. The plate, whose peripheral part is received from below by a peripheral part of the drain hole of the fitting recess, is made thick enough to enable attachment of the cover in a fitted state. In a position facing the drain hole, there is pierced a net inserting hole into which a lower end of the bag-shaped rubbish straining net having a one-end opening under an opened state can be inserted and through which the drainage can pass. The plate is equipped with a rubbish straining net supporting means for supporting the rubbish straining net in an opened state by locking a peripheral part of the opening of the rubbish straining net in a state in which the lower end of the rubbish straining net is inserted into the net inserting hole.

Patent Publication No. JP 8319001A to Fukazawa Kiyoshi entitled: “Throw Away Garbage Storage Bag For Sink Drainage Port”, which is incorporated in its entirety for all purposes as if fully set forth herein, discloses an easily perform processing so as to be clean and convenient without washing a rubber storage bag by forming it in a throw-away type, through sticking slime of strong adhesion due to propagating various germs, when used a garbage storage bag to be mounted in a sink drainage port by providing a ring in an upper part of the garbage storage bag. In this application a ring is provided in an upper part of a garbage storage bag. A retaining ring for fixing the rubber storage bag 1 to the ring is provided. This bag, when it is used, is mounted in a sink drainage port for use. After used, the bag is left as it is and thrown away. Further in the rubber storage bag, network vinylon-made nonwoven fabric, polyester-made knit punch applied polyethylene-made film, etc., only with dewatering, may be used. The garbage storage bag, thus formed in a throw-away type, can be easily processed with cleanliness without washing. By simplifying mounting/demounting the bag and by a throw-away type, it is clean and convenient.

In consideration of the foregoing, it would be an advancement in the art to provide a better, simple, cost-effective, convenient, and easier to use means for cleaning or maintaining the cleanliness of a sink.

### SUMMARY

A better and easier to use container for cleaning or maintaining the cleanliness of a sink is disclosed, based on fitting a disposable container with a hole into a sink covering the sink; and the hole of the disposable container is fitted for a drainage opening of the sink for, but not limited to, liquids draining into the drainage opening of the sink, keeping the sink clean from oil, spices that leave color in the sink (such as saffron and paprika), and having the container without liquids in it for dispose into the garbage bin.

A disposable flexible container for installation in a sink, the sink comprises an upper opening and a bottom opening for draining, is disclosed. The container comprising an upper opening and a bottom opening. When the container is installed in the sink, the walls of the container are adjacent or attached, fully or partially, to the sides of the sink, the container upper opening is fitted, fully or partially, to the sink upper opening, and the container bottom opening is fitted, fully or partially, to the sink bottom opening.

The container may be made of flexible materiel that is plastic, LDPE (Low Density Polyethylene), LLDPE (Linear Low Density Polyethylene), HDPE (High Density Polyethylene), or Oxo-biodegradable.

The container upper opening is operative to be closed, using ties that are threaded, fully or partially, through the upper opening of the container.

The container upper opening comprises adhesives strips for attaching the container to a rim of the sink. The adhesives strips may be hot melt adhesives.

The sink further comprises elements mounted to a rim of the sink, and the upper opening of the container comprises mating holes for engagement with the elements. The elements may be vacuum cups.

The container bottom opening is narrower than the container upper opening is disclosed. The container further comprising a strainer for filtering liquids installed in the container bottom opening. The strainer is made of a metal, aluminum, stainless steel, or plastic strainer. The strainer is perforated using holes wherein the holes diameter is less than 10 millimeters or less than 5 millimeters.

The sink is a bowl-shaped plumbing fixture used for washing hands or dishwashing; and having at least one tap and a drainage opening for draining the water from the tap.

A method for maintaining of a clean sink using a flexible container adapted to be installed in the sink is disclosed. The method comprising the steps:
a. installing the container in the sink in a way that the container walls are adjacent, fully or partially, to the sides of the sink for capturing a garbage by the container during a use of the sink; and
b. removing the container containing the captured garbage from the sink.

The method wherein the container comprises a bottom opening for filtering liquids, and the container is installed so that the container bottom opening is fitted, fully or partially, to a bottom opening of the sink is disclosed. The method further comprising the step of waiting, after a use in the sink, for filtering liquids that accumulated in the container through the bottom opening of the container.

The method further comprising the step of closing the container for keeping the garbage inside the container by closing the upper opening of the container. The closing of the upper opening of the container may be by tying ties that are threaded, fully or partially, through the upper opening of the container.

### BRIEF DESCRIPTION OF THE DRAWINGS

The invention is herein described, by way of non-limiting examples only, with reference to the accompanying drawings, wherein like designations denote like elements. Understanding that these drawings only provide information concerning typical embodiments of the invention and are not therefore to be considered limiting in scope:

FIG. 1 schematically illustrates a sink;

FIG. 2a schematically illustrates a disposable container;

FIG. 2b schematically illustrates a closed disposable container;

FIG. 2c schematically illustrates a further embodiment of an open disposable container;

FIGS. 3a and 3b schematically illustrate a disposable container in a sink;

FIG. 4 schematically illustrates a cross section of a sink fully covers by a disposable container;

FIG. 5 schematically illustrates a disposable container filled with garbage in a sink;

FIG. 6 schematically illustrates a removing a disposable container filled with garbage from a sink; and

FIG. 7 schematically illustrates a flow-chart diagram of using a disposable container.

### DETAILED DESCRIPTION

The principles and operation of a method and container for cleaning a sink according to the present invention may be understood with reference to the figures and the accompanying description wherein similar components appearing in different figures are denoted by identical reference numerals. The drawings and descriptions are conceptual only. In actual practice, a single component can implement one or more functions; alternatively or in addition, each function can be implemented by a plurality of components and devices. In the figures and descriptions, identical reference numerals indicate those components that are common to different embodiments or configurations. Identical numerical references (even in the case of using different suffix, such as 5, 5a, 5b and 5c) refer to functions or actual devices that are either identical, substantially similar, or having similar functionality. It will be readily understood that the components of the present invention, as generally described and illustrated in the figures herein, could be arranged and designed in a wide variety of different configurations. Thus, the following more detailed description of the embodiments of the disposable container and method of the present invention, as represented in the figures herein, is not intended to limit the scope of the invention, as claimed, but is merely representative of embodiments of the invention. It is to be understood that the singular forms “a,” “an,” and “the” herein include plural referents unless the context clearly dictates otherwise. By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

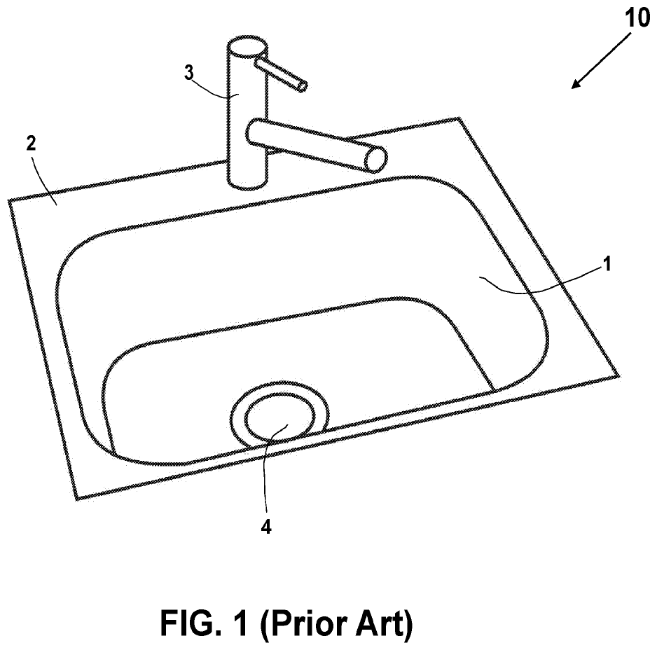

FIG. 1 illustrates a sink 10. The sink 10 comprising a typical bowl-shaped plumbing fixture 1 used for washing hands, dishwashing, and other purposes, a rim 2, a tap 3, and a drainage opening of the sink 4.

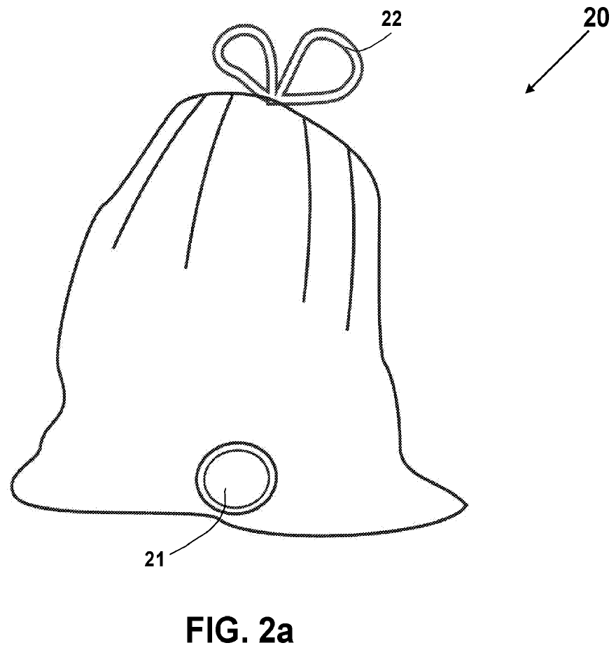

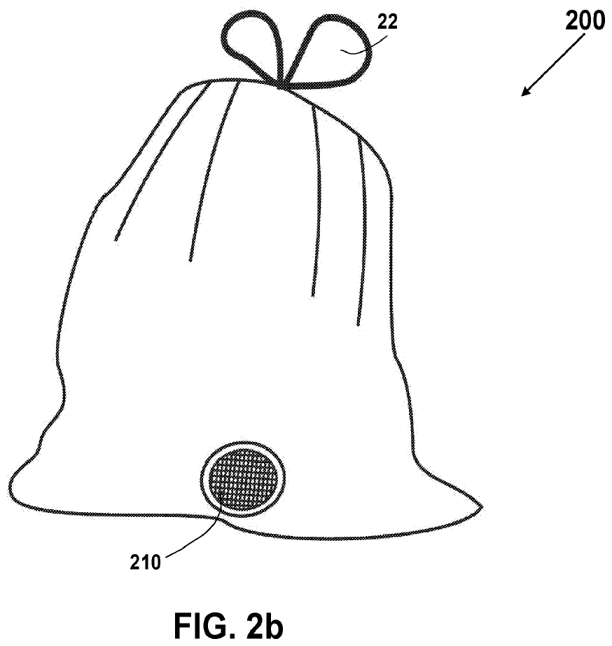

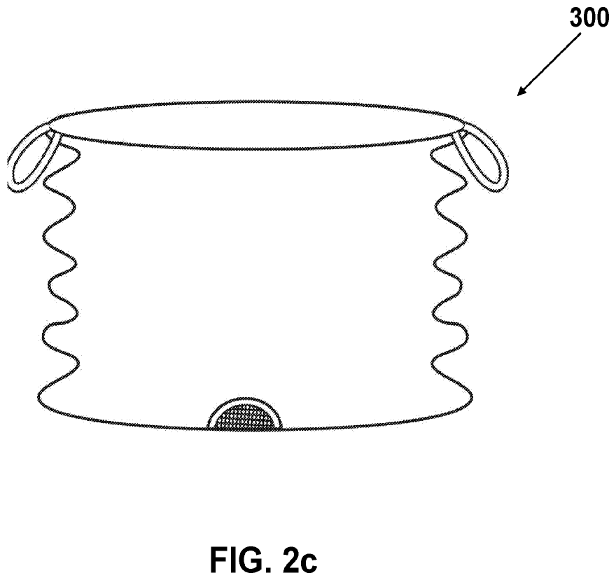

FIG. 2a illustrates a disposable container 20. The disposable container 20 may be a bag having a bottom opening such as a hole 21. The disposable bag 20 may be closed with ties 22 that may be twist ties or any kind of ties, or may be otherwise closed without using ties. FIG. 2b illustrates a view of another example of a disposable bag 200 in a closed position. In this example the disposable bag 200 comprising a hole having a strainer 210. In this embodiment of a disposable bag, the strainer 210 is perforated to prevent from small parts of garbage to be drained into the plumbing system and clogging it up.

FIG. 2c illustrates a further embodiment of a disposable container 300 in an opened position where the container made of flexible materiel such of plastic, LDPE (Low Density Polyethylene), LLDPE (Linear Low Density Polyethylene), HDPE (High Density Polyethylene) or Oxo-biodegradable.

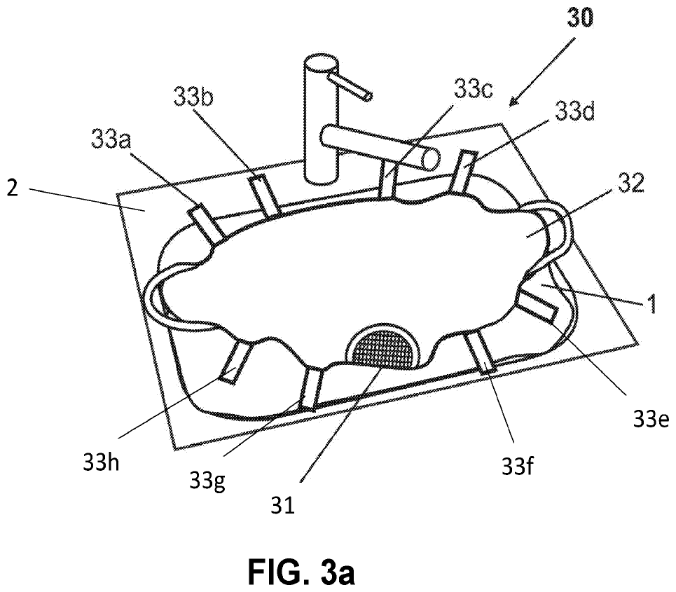

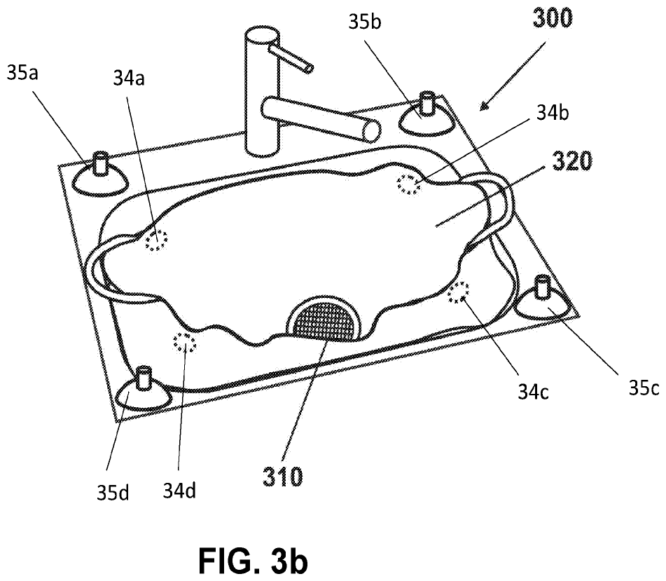

FIG. 3a illustrates a view 30 of a disposable container 32 in a sink. The disposable container 32 partially covers the bowl-shaped plumbing fixture 1 of the sink. The hole 31 of the disposable container is placed above the drainage opening of a sink 4, as shown in FIG. 1. The disposable container 32 comprises adhesives strips 33a, 33b, 33c, 33d, 33e, 33f, 33g and 33h at the upper side of the disposable container 32. For example, hot melt adhesives for disposable products may be used. The adhesive strips 33a, 33b, 33c, 33d, 33e, 33f, 33g and 33h are placed on, or attached to, the rim 2 of the sink 30 to prevent or minimize any movement of the disposable container.

FIG. 3b illustrates a view 300 of a further embodiment of disposable container 320 in a sink. The disposable container 320 partially covers the bowl-shaped plumbing fixture of the sink. The disposable container 320 includes a strainer 310 in the bottom of the disposable container 320. The disposable container 320 comprises holes 34a, 34b, 34c and 34d at the upper side of the disposable container 32 for engagement with elements mounted to the rim 2 of the sink. For example, the elements may be vacuum cups 35a, 35b, 35c and 35d. Other or no means of sticking the disposable bag to the rim of the sink may be equally used.

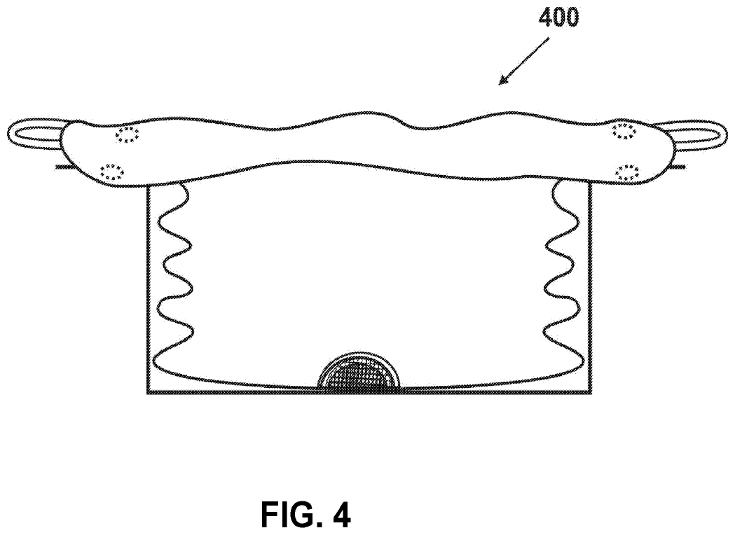

FIG. 4 illustrates a cross section of a sink 400 fully covered by a disposable container.

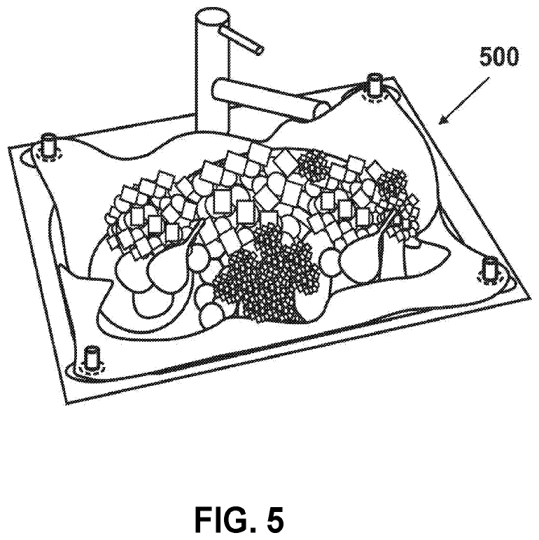

FIG. 5 illustrates a view 500 of a disposable container full with garbage in a sink. The holes 34a, 34b, 34c and 34d, as shown in FIG. 3b were inserted into the vacuum cups 35a, 35b, 35c and 35d, also shown in FIG. 3b for preventing or minimizing any movement of the disposable container.

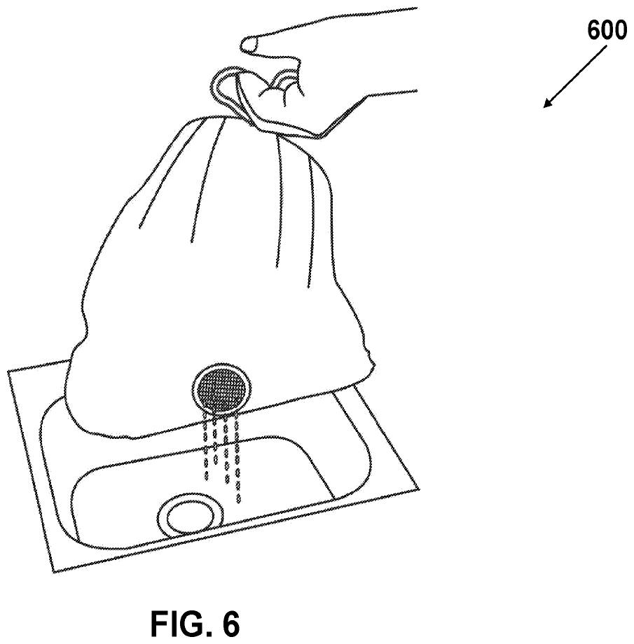

FIG. 6 illustrates a view 600 of a disposable bag full with garbage taken out from a sink, while leaving the sink clean from garbage.

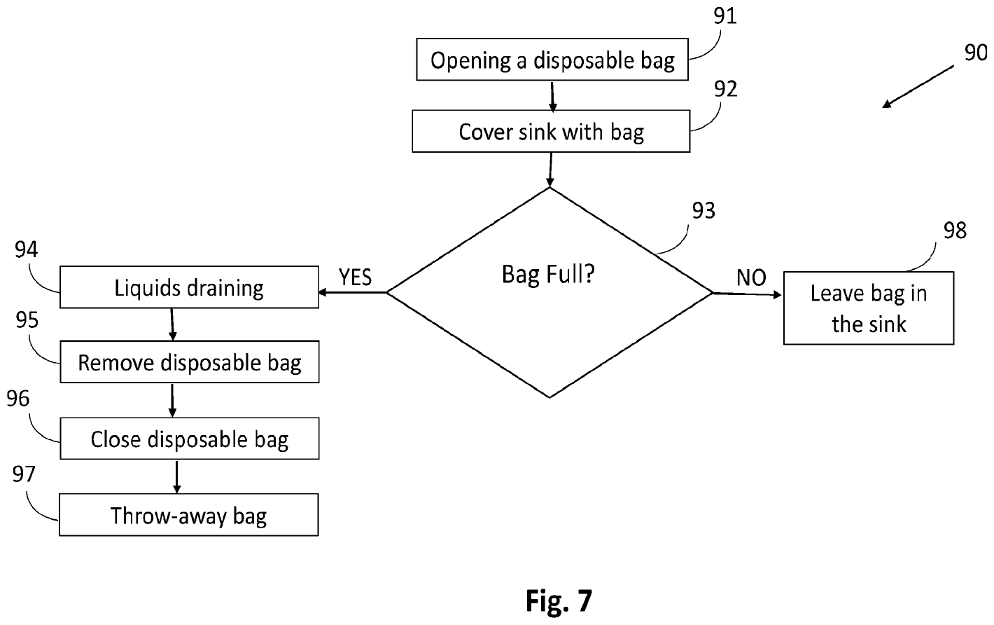

FIG. 7 illustrates a flow-chart diagram 90 of using a disposable bag. The flow chart 90 starts at an “Opening a disposable bag” step 91, where a user obtains and opens the disposable bag for using it. Then, in a “Cover sink with bag” step 92, the user covers the sink, fully or partially, with the disposable container. Next, in a “Bag full?” step 93, the status of the disposable container is checked. If the value is “YES”, meaning that the container is full and should be removed, then a “Liquids draining” step 94 is performed, in which the user lets the liquids and other small parts that are in the disposable container to be drained into a drainage opening of the sink. Thereafter, as part of a “Remove disposable bag” step 95, the user removes the disposable container from the sink, and closes the disposable container as part of a “Close disposable bag” step 96, followed by throwing-away the disposable container into a garbage bin as part of a “Throw away bag” step 97.

If the result of the “Bag full?” step 93 is “NO”, then the user keeps the disposable container in the sink until the end of use in the disposable container, as part of a “Leave bag in the sink” step 98.

The terminology used herein is for the purpose of describing particular embodiments only, and is not intended to be limiting of the invention. As used herein, the singular forms “a”, “an” and “the” are intended to include the plural forms as well, unless the context clearly indicates otherwise. It will be further understood that the root terms “include” and/or “have”, when used in this specification, specify the presence of stated features, integers, steps, operations, elements, and/or components, but do not preclude the presence or addition of one or more other features, integers, steps, operations, elements, components, and/or groups thereof. The terms “plurality” and “a plurality” as used herein includes, for example, “multiple” or “two or more”. For example, “a plurality of items” includes two or more items.

Although exemplary embodiments of the present invention have been described, this should not be construed to limit the scope of the appended claims. Those skilled in the art will understand that modifications may be made to the described embodiments. Moreover, to those skilled in the various arts, the invention itself herein will suggest solutions to other tasks and adaptations for other applications. It is therefore desired that the present embodiments be considered in all respects as illustrative and not restrictive, reference being made to the appended claims rather than the foregoing description to indicate the scope of the invention.

In addition, in this disclosure, certain process steps are set forth in a particular order, and alphabetic and alphanumeric labels are used to identify certain steps. Unless specifically stated in the disclosure, embodiments of the invention are not limited to any particular order of carrying out such steps. In particular, the labels are used merely for convenient identification of steps, and are not intended to imply, specify or require a particular order of carrying out such steps. Furthermore, other embodiments may use more or less steps than those discussed herein.

All publications, patents, and patent applications cited in this specification are incorporated herein by reference as if each individual publication, patent, or patent application were specifically and individually indicated to be incorporated by reference and set forth in its entirety herein.

What is claimed is:

1. A disposable flexible container configured to be installed in a sink, the sink including a sink upper opening, a sink lower drainage opening, side walls and a rim, the container comprising:
a flexible bag whose upper opening is configured to attach to the rim at separate discrete points along the rim,
the bag having a container upper opening and a container bottom opening and a side wall, the side wall having an outer surface,
the bag configured to be installed in the sink such that:
(a) the bag is partially adjacent portions of the side walls of the sink such that a first portion of the outer surface of the side wall of the bag is adapted to be positioned flush against a first portion of the side walls of the sink while at the same time another portion of the outer surface of the side wall of the bag is adapted to be positioned so as to not be flush against the side walls of the sink,
(b) the container upper opening is fitted, partially, to the sink upper opening such that liquid contents and non-liquid garbage in the bag do not escape through the container upper opening and are instead passed to the sink lower drainage, and
(c) the container bottom opening is configured to be fitted, fully, to the sink bottom opening and adapted with perforations for passing the liquid contents to the sink lower drainage opening and for capturing at least part of the non-liquid garbage.

2. The container of claim 1, wherein the rim of the sink has rounded corners and the upper opening of the flexible bag is configured to attach to the rim at separate discrete points along the rim including at points other than the rounded corners.

3. The container of claim 1, wherein the upper opening of the flexible bag is configured to attach to a rim of the sink only at the separate discrete points along the rim.

4. The container of claim 1, wherein the sink further comprises elements mounted to the rim and the upper container opening comprises mating holes for engagement with the elements.

5. The container of claim 4, wherein the elements are vacuum cups.

6. The container of claim 1, wherein the container is made of a single layer flexible material that is non-water absorbent plastic, LDPE, LLDPE, HDPE or Oxo-biodegradable.

7. The container of claim 1, wherein the container further comprises two handles for hand-carrying the container and for enclosing the non-liquid garbage.

8. The container of claim 7, wherein the container upper opening is operative to be closed using threaded ties.

9. The container of claim 1, wherein the container upper opening comprises adhesive strips for attaching the container to the rim of the sink.

10. A method of maintaining a clean sink using a flexible container adapted to be installed in the sink, the sink including a sink upper opening, a sink lower drainage opening, side walls and a rim, the method comprising:
installing in the sink a container comprising a flexible bag having a container upper opening, a container bottom opening and a side wall, such that
(a) an upper opening of the flexible bag is configured to attach to the rim of the sink at separate discrete points along the rim,
(b) the bag is partially adjacent portions of the side walls of the sink such that a portion of an outer surface of a side wall of the bag is positioned flush against a portion of the side walls of the sink while at the same time another portion of the outer surface of the side wall of the bag is positioned so as to not be flush against the side walls of the sink in the installed position,
(c) the container upper opening is fitted, partially, to the sink upper opening such that liquid contents and non-liquid garbage in the bag do not escape through the container upper opening and are instead passed to the sink lower drainage, and
(d) the container bottom opening is fitted, fully, to the sink bottom opening.

11. The method of claim 10, further comprising using the sink such that liquid contents of the bag are passed to the sink lower drainage opening and at least part of a non-liquid garbage is captured within the container by perforations in the container bottom opening.

12. The method of claim 11, further comprising closing the container upper opening and lifting the bag, thereby providing that further liquid contents are passed to the sink lower drainage opening.

13. The method of claim 10, wherein the sink has rounded corners and wherein the upper opening of the flexible bag is configured to attach to the rim of the sink at separate discrete points along the rim including at points other than the rounded corners.
